(19) United States
(12) Patent Application Publication
(10) Pub. No.: US 2002/0098466 A1
(43) Pub. Date: Jul. 25, 2002

(54) Career specific development system

(75) Inventors: Michael P. Laddin, Shawnee, KS (US); Jon W. Hope, Shawnee, KS (US)

Correspondence Address: HOVEY, WILLIAMS, TIMMONS & COLLINS, Suite 400, 2405 Grand, Kansas City, MO, 64108, US

(73) Assignee: The General Manager Development Company, LLC

(21) Appl. No.: 09/769,662

(22) Filed: Jan. 25, 2001

(51) Int. Cl. G09B 19/00

(52) U.S. Cl. 434/237

(57) ABSTRACT

A career specific development system develops a mindset in a group of learners wherein the learners have a common career and the mindset is specific to the common career. The career specific mindset must first be identified. In particular, the set of knowledge, values and beliefs possessed by experts in the career must be determined. The learners are then placed in a learning environment to develop the mindset. The learning environment particularly involves exposing the learners to an ambiguous problem situation requiring a risk-associated response from the learners. The ambiguity and risk create a level of uncertainty in the learners sufficient to motivate them to develop the mindset. Intervention in the learners' exposure to the situation is then utilized to reinforce the learners' development or to modify the level of uncertainty until the desired motivational level is achieved. Once the motivational level is achieved, mindset-specific content is presented to the learners to optimize the development of the mindset.

### BACKGROUND OF THE INVENTION

1. Field of the Invention

The present invention relates generally to development systems. More specifically, the present invention concerns a career specific development method that involves identifying a mindset specific to the common career of a group of learners and then placing the learners in an environment to develop the mindset.

2. Discussion of Prior Art

Although numerous career-oriented development programs exist, it is believed that such programs have heretofore failed to provide the fundamental training necessary to excel in the career. The deficiencies of existing programs is believed to be attributable to several problematic qualities for example, most, if not all, known career-oriented development programs focus on teaching rather than learning. It is particularly believed that participants of teaching programs become dependent on the program and their degree of learning is a function of the curriculum. That is not to say, however, that existing career-oriented learning programs are successful. Although learning programs typically involve more situational participation than teaching programs, it is believed that traditional learning programs do not account for the participants' individual knowledge levels and learning capabilities.

### OBJECTS AND SUMMARY OF THE INVENTION

Responsive to these and other problems and in accordance with the objects evident from the following description of the preferred embodiment, the present invention concerns a career specific development system including the steps of identifying a mindset specific to the common career of a group of learners and placing the learners in an environment to develop the mindset. In the preferred embodiment, identifying the mindset includes the steps of interviewing workers that have done effective work in the learners' common career to determine the knowledge, values and beliefs specific to the effective work. The step of placing the learners in an environment to develop the mindset preferably includes the steps of exposing the learners to an ambiguous decision to create a level of uncertainty sufficient to motivate the learners to learn the knowledge, values and beliefs, eliciting a risk-associated response from the learners and then presenting mindset-specific content to the learners to modify future responses in order to reduce the associated risk.

Other aspects and advantages of the present inventive system will be apparent from the following detailed description of the preferred embodiment and the accompanying drawing figures.

### BRIEF DESCRIPTION OF THE DRAWING FIGURES

A preferred embodiment of the inventive system is described in detail below with reference to the attached drawing figures, wherein:

FIG. 1 is a flow diagram illustrating the steps of developing a career specific mindset in a group of learners, wherein the learners have a common career and the mindset is specific to the common career;

FIG. 2 is a Venn diagram of the step of placing the learners in a learning environment to develop the mindset particularly showing the interaction of the steps of exposing the learners to a problem situation, intervening in the learners' exposure to the situation, and presenting mindset-specific content to the learners, to achieve the preferred level of learning;

FIG. 3 is three Venn diagrams illustrating at least one of the learner's existing mindset as the learning environment adjusts over time to achieve the preferred level of learning;

FIG. 4 is a flow diagram of an alternative embodiment of the present inventive system, wherein a learner that withdraws from the learning environment is placed in an alternative environment; and

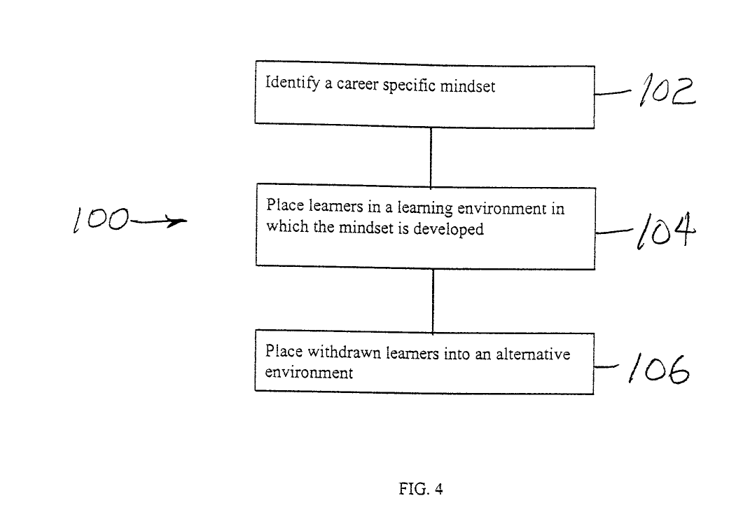

FIG. 5 is a flow diagram of an alternative embodiment of the present inventive system illustrating the steps of developing a career specific mindset in a single learner, wherein the mindset is specific to the leaner's career.

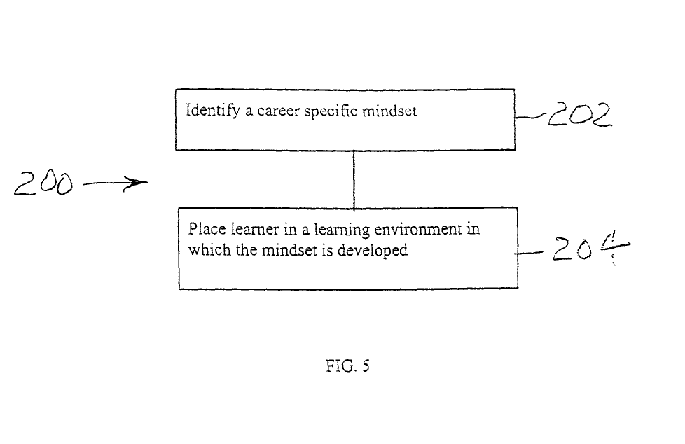

### DETAILED DESCRIPTION OF THE PREFERRED EMBODIMENT

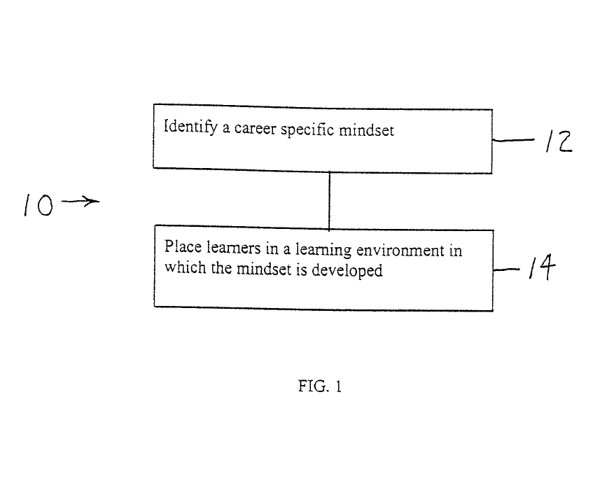

With respect to FIG. 1, the career specific development method selected for illustration comprises a series of steps, generally referenced by the numeral 10, that are preferably performed in sequence. Generally speaking, the illustrated method 10 includes step 12 of identifying a mindset specific to a common career of a group of learners and step 14 of placing the learners in an environment to develop the mindset.

Those ordinarily skilled in the art will appreciate that development methods typically target one of three general areas of learner growth; personal development, specialist development or professional development. Personal development programs help learners acquire basic skills applicable to the competency of the person, and include methods ranging from programs directed at learners in their early childhood to complex courses, such as a Dale Carnagie course. Specialist development programs help learners acquire specialized skills applicable to the competency of the learner in a specialized area associated with the work the learner does, and are typically in a seminar format (e.g., Financial or Marketing seminars). Professional development programs help learners acquire skills applicable to their competency in their profession, and include methods ranging from the “school of hard knocks” to advanced electrical apprenticeships, legal internships and medical residencies. As will become apparent, the career specific development method 10 is applicable to developing learner growth in any and/or all three general areas of learner growth, but is particularly suited for professional development of the learners.

The career specific development method 10 is particularly designed for developing a mindset in a group of learners, wherein the learners share a common career and the mindset is specific to the common career—for example the group of learners may comprise general managers of a multi-national company and the mindset is specific to being an effective general manager. However, as will be described, the principles of the present invention are equally applicable to developing a mindset in a single learner. For example, in the hypothetical previously described, the multi-national company may have a particular general manager that is less effective than the other general managers and the company desires to develop the effective general managers' mindset in the less effective general manager.

Turning initially to step 12, identifying the mindset to be developed in the learners preferably includes determining a set of knowledge, values and beliefs to be developed in the learners. Every expert acquires a mindset (a set of knowledge, values and beliefs) specific to his/her area of expertise. The expert uses this mindset in every situation he/she confronts. The expert mindset is the learning goal and more precisely is the set of knowledge, values and beliefs to be developed in the learners. The mindset is career specific, however, the mindset is universal to that career regardless of the industry setting (e.g., the mindset specific to general managers applies to all learners that are general managers whether they work in telecommunications, manufacturing, sales, etc.). Accordingly, the group of learners could comprise learners from several different industries, so long as they share a common career.

Knowledge is an understanding of, or information about something, typically acquired through reading or hearing. Knowledge also includes ability; that is to say, an understanding of, or information about, how to do something, typically acquired through doing and practicing. Values are perceptions of the relative importance of things, typically acquired through achieving or failing. Beliefs are attitudes toward, interests in, and/or willingness to do, things, typically acquired through listening and watching. For example, an effective surgeon has a mindset that may comprise: information about anatomy and an understanding how to handle internal organs (knowledge); perceiving being right and in control as important (values); and an attitude toward the worth of surgery and medicine (beliefs). An effective sales person has a mindset that may comprise: information about the product and an understanding how to cultivate interest (knowledge); perceiving personal success as important (values); and an interest in competition (beliefs). An effective attorney has a mindset that may comprise: information about the law and an understanding how to apply legal concepts (knowledge); perceiving control and being right as important (values); and a willingness to compromise (beliefs).

Identifying the mindset (i.e. determining a set of knowledge, values and beliefs) in step 12 is preferably done by interviewing workers that have done effective work in the learners' common career to identify what the workers know about when doing the effective work, what the workers know how to do when doing the effective work, what the workers value when doing the effective work, and what the workers believe in when doing the effective work. The interview is preferably organized according to general topic areas, and structured with both broad and probing questions within each topic area. The broad questions will elicit statements from the workers that can be attributed to one of three possible combinations of knowledge, values and beliefs: judgments comprising knowledge and values, opinions comprising knowledge and beliefs, and principles comprising values and beliefs. The probing questions will further identify which (knowledge, values or beliefs) is controlling. Statements from the workers that are controlled by knowledge will tend to be characterized by rationality, referring to “it,” or using concepts, constructs, and logic. Statements from the workers that are controlled by values will tend to be characterized by emotions, referring to “I, me or you,” or using perception, assumption, and motive. Statements from the workers that are controlled by beliefs will tend to be characterized by non-rationality, referring to “we, they or us,” or using attitudes, interests, and willingness.

Using the general manager (“GM”) hypothetical discussed above, general topic areas for an interview with general managers that have done effective work as general managers could include: the unique nature and universe of GM action (what is the role of a GM), the unique contributions of a GM (what does a GM do), the concerns and issues encountered in doing GM work (what is important in doing the work of a GM), and how the GM relates to other areas within the firm (how do GMs relate to other functions within the company). Probing questions concerning the role of a GM could include: why do companies have GMs, what issues are appropriate for a GM, and what are the 3-5 main issues that concern you most often. These questions are seeking the following information, respectively: the role of the professional within the company, the broad functions of the professional, and the main areas of performance. In the respective answers to these questions, the interviewer should look for the following: the basic aims from which performance is derived, the specific performance areas mentioned and what is mentioned and how (i.e. as knowledge, values or beliefs).

Identifying the mindset (i.e. determining a set of knowledge, values and beliefs) in step 12 could also be done by interviewing coworkers of the learners to identify what the learners need to know about to do effective work, what the learners need to know how to do to do effective work, what the learners should value to do effective work, and what the learners should believe in to do effective work. The two preferred groups of interviewees are not mutually exclusive and one or more interviewees could both be a coworker and a worker that has done effective work in the learners' common career. For example, in the GM hypothetical, the group of learners could include GMs in the same company that do ineffective work in a particular area and the interviewees could include GMs from the same company that do effective work in the particular area and recognize why the learners do ineffective work in that area.

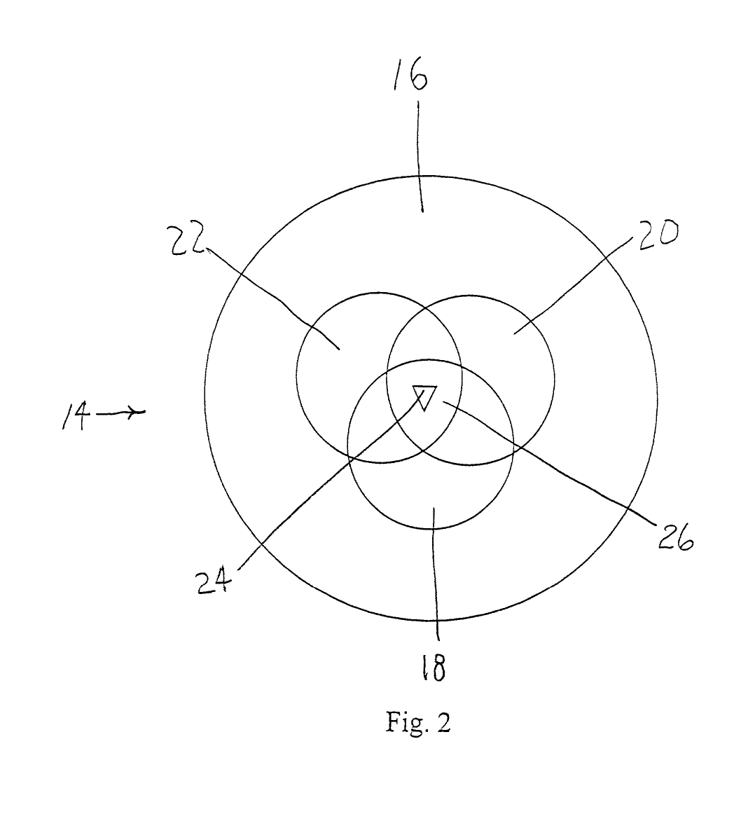

Turning to FIG. 2, the Venn diagram depicts step 14 of placing the learners in a learning environment 16 to develop the mindset. Step 14 preferably includes step 18 of exposing the learners to a problem situation, step 20 of intervening in the learners' exposure to the problem situation, and step 22 of presenting mindset developing content to the learners. The problem situation of step 18 must be designed to develop the mindset identified in step 12. The learning environment 16 is preferably non-directive and highly reactive. In this regard, in the preferred embodiment, the problem situation of step 18 includes a simulation comprising tasks assigned to the learners and situational factors relevant to the mindset to be developed (e.g. materials, people, and conditions). The situation preferably contains inherent ambiguity. That is to say, the learning situation is somehow different from similar situations previously encountered by the learners. The situation preferably requires a response by the learners and the response preferably has a risk associated with the response. In the preferred embodiment, the inherent ambiguity and risk-associated response are designed to create a level of uncertainty in the learners sufficient to motivate the learners to learn the mindset to be developed. For example, in the GM hypothetical, the problem situation could include the running of one of several medium-sized manufacturing “firms” wherein each learner is assigned a position on the management team of one of the firms. Each firm would compete with other firms (both learner-managed and simulated firms). The learners would operate the firm, perform the required support and conduct the business, including the making of all strategic, tactical, and operational decisions. The learners would respond to the changing surroundings and prepare reports to their board of directors. Theoretical relationships (e.g., stable economic analysis) could be altered (e.g., price increases may not lead to reduced demand).

Step 20, intervening in the learners' exposure to the problem situation, includes all actions by people outside the group of learners which intervene in the learners' exposure to the problem situation. In the preferred embodiment, the actions include providing performance feedback to the learners and creating, or reducing, uncertainty in the learners. To develop the desired mindset in the learners, the method 10 must build on the learners' existing mindset. In this regard, performance feedback preferably includes asking questions of the learners as to why specific actions were taken and why specific factors were included or excluded. As discussed above in connection with step 18, the preferred problem situation creates a level of uncertainty in the learners sufficient to motivate the learners to learn the mindset to be developed. If this motivational level of uncertainty is not achieved in one or more of the learners (i.e. the level of uncertainty in one or more of the learners is either too low or too high to motivate the desired learning), then step 20 preferably includes intervening in the one or more of the learners' exposure to the problem situation to either create more uncertainty or respond to the excessive uncertainty in order to reduce it, respectively, until the motivational level of uncertainty is achieved. For example, in the GM hypothetical, performance feedback intervention actions could include stopping one of the management team members (i.e. one of the learners) during their performance of the operating the firm task and asking them to identify the type of organization they have setup (e.g., cooperative, competitive, or political) and why they believe in that type of organization. This intervention focuses on the learners' belief in cooperation. Creating or reducing uncertainty intervention actions could include modifying one or more of the situational factors to make the problem situation more or less complex.

Step 22, presenting mindset developing content to the learners, includes the presentation of any and all concepts, constructs, and logic to the learners. In the preferred embodiment, the concepts, constructs and logic are appropriate to developing the mindset identified in step 12. As discussed above in connection with step 18, the preferred problem situation requires a risk-associated response by the learners. In addition, the preferred problem situation creates a level of uncertainty in the learners sufficient to motivate the learners to learn the mindset to be developed. The mindset development of method 10 is optimized when learning opportunities correlate with mindset development. In this regard, the presentation of step 22 preferably occurs when the learner is motivated to learn the mindset to be developed. The concepts, constructs, and logic presented to the learners in step 22 preferably assist the learners in responding appropriately to risk. For example, in the GM hypothetical, if the mindset to be developed includes valuing performance over popularity and in step 18 at least one of the learners was put in-charge of their firm's accomplishment of some identified work that is not getting done, step 22 may include: once the learner has become frustrated (i.e. motivational level of uncertainty) by the inability to get the work done yet does not take appropriate steps to get it done (i.e. risk-associated response), the learner could be presented with the concept of valuing performance over popularity. The presentation maybe as simple as asking the learner why the work is not getting done and what needs to be done in order to get the work done; once the learner has answered, then ask why the learner did not (or does not) do that.

As discussed above, to develop the desired mindset in the learners, the method 10 must build on the learners' existing mindset. In this regard, the preferred embodiment includes step 24, assessing each of the learners' existing mindset. As shown in FIG. 2, step 24 can be included in any one of steps 18, 20 or 22. Step 24 can also be included (and repeated) in one or more, or all of steps 18, 20 and 22. That is to say, an important parameter in the application of the mindset development method 10 is the existing mindset of the learners at any given point along the method 10 time continuum. In step 18, exposing the learners to a problem situation, the preferred inherent ambiguity and created motivational level of uncertainty will only exist in the mind of the learners. Based on the learners' existing mindset, one or more of the learners may be placing importance, or responding to, the wrong things in the problem situation. One or more of the learners may not initially recognize that the problem situation is somehow different from similar situations they have previously encountered. As will become apparent, when step 24 is included in step 18 the learners' existing mindset can be assessed and the problem situation of step 18 can be accommodated to provide the one or more of the learners with sufficient evidence that something is different. When step 24 is included in step 20, intervention can be used to reinforce the difference. Similarly, when step 24 is included in step 22, content can be presented that utilizes the difference.

As shown in FIG. 2, the preferred level of learning 26 (i.e. knowledge, values and beliefs) occurs in the interaction of steps 18, 20 and 22. Step 18, 20 or 22 in isolation cannot develop the preferred knowledge, values and beliefs in the learners. Specific levels of learning 26 correspond to specific interaction of steps 18, 20 and 22. In the preferred embodiment, step 14 includes the step of assessing the learning environment 16 and the step of modifying the environment 16 to achieve the preferred level of learning 26. The interaction of steps 18, 20 and 22 can be increased or decreased accordingly in response to the assessment of the environment 16 in order to achieve the desired level of learning 26. The step of assessing the learning environment 16 may include weighing relevant factors such as the experience of the learners (as determined in step 24), the nature of the learning environment 16 and the difficulty of the mindset to be developed (as determined in step 12). The preferred level of learning 26 does not proceed entirely along one dimension. That is, the learners will not learn just knowledge or values or beliefs, they will learn all three. In addition, the learners' experience (i.e. existing mindset as determined in step 24) will most likely vary on one or more dimensions. Moreover, the appropriate (i.e. motivational) level of ambiguity, uncertainty and risk associated with step 18 will vary depending on the dimension to be developed.

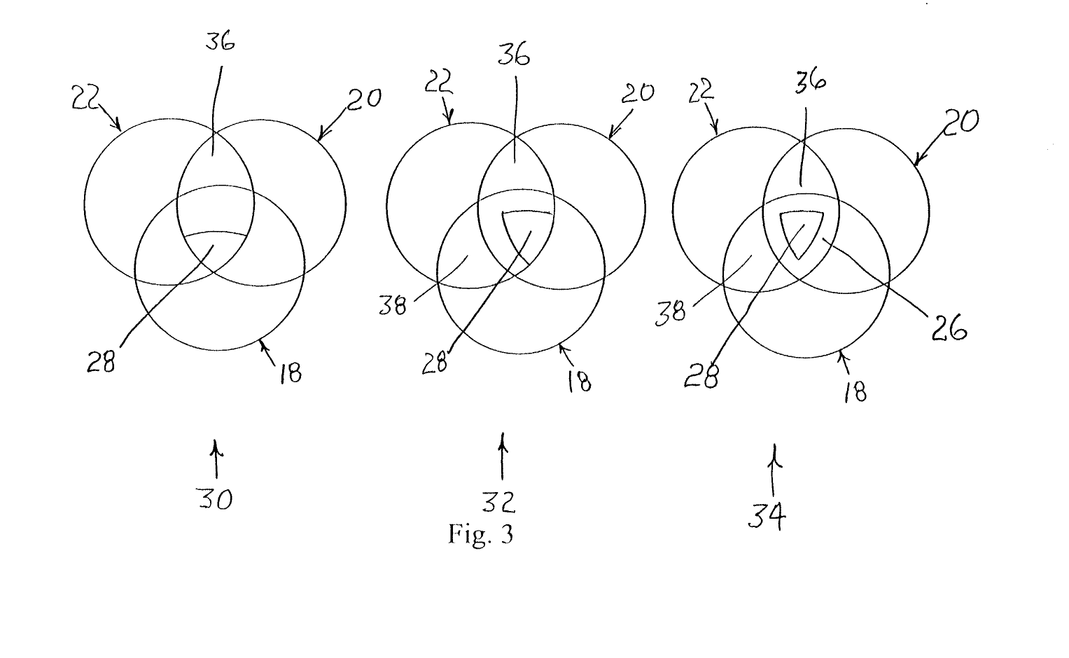

For these reasons and others, the learning environment 16 of the preferred embodiment is operable to accommodate and adjust to these variances. In FIG. 3, three Venn diagrams 30, 32 and 34 illustrate at least one of the learner's existing mindset 28 (as determined in step 24) in relation to the interaction of steps 18, 20 and 22 as the learning environment 16 (not shown) adjusts (in time) to achieve the preferred level of learning 26. Diagram 30 represents mindset 28 at a point in time just after the learners are exposed to a problem situation in step 18. Learner is drawn to ambiguity 36 by the situation created in step 18. Diagram 32 represents mindset 28 at a point in time just after intervention in the learners' exposure to the situation in step 20 occurs. Uncertainty 38 has been increased by the intervention. Diagram 34 represents mindset 28 at a point in time just after presentation of mindset developing content in step 22 occurs. The preferred level of learning 26 has been achieved so that ambiguity 36, uncertainty 38 and risk have all been reduced. Ambiguity 36 is reduced because learner develops perceptions and concepts; judgment improves allowing improved ability to correctly identify relevant factors. Uncertainty 38 is reduced because learner develops constructs and interests; principles improve allowing improved ability to correctly interpret relevant combinations of factors. Risk is reduced because learner develops will and motives; opinions improve allowing ability to correctly form intention.

While the learning environment 16 is operable to accommodate and adjust to variances, that is not to say the accommodations and adjustments are unpredictable. For example, it has been determined that the step 20 of intervening in the learners' exposure to the problem situation is highly predictable. Typically, the same or similar interventions are utilized at the same or similar stage in the problem situation from one group of learners to the next.

### EXAMPLE

The following discussion is an example of the career specific mindset development method 10 in operation. It will be appreciated that this example picks up at step 14 of placing the learners in the learning environment 16 after the mindset has been determined. With respect to this example, determining the mindset of an expert general manager, previously exemplified (the GM hypothetical) will not be repeated here. It will be further appreciated that this example does not illustrate any of the steps associated with learner withdrawal (which will subsequently be described). The group of learners share the common career of general managing. The mindset to be developed in the learners therefore is that of an expert general manager. As previously determined, effective general managers know how to identify and seize opportunity, bring people together, identify and remove barriers to communication, and create and use vision. Effective general managers value achievement of the common end, performance, integrity, and trust. Effective general managers believe in cooperation, accountability, responsibility, and free-will choice.

The learners are divided into subgroups of approximately six learners each. Each subgroup is exposed to a problem situation consisting of running a simulated business. The learners are provided with all the data that any typical business would have access to (e.g., profit and loss statements, marketing reports, sales reports, production reports, balance sheet reports, cash flow reports, cost reports, etc.). The learners are required, in running their business, to make decisions twice a day—decisions similar to those made in any typical business (e.g., sales price, salaries, production, inventory, cash, investments, etc.). Each learner is given a functional title within their business (e.g., president, vice president in charge of one of various departments, etc.). The business has a problem situation that in reality has a relatively simple solution that one person working alone with a calculator and a piece of paper could probably solve in about three hours. However, because human beings have a natural tendency not to cooperate and not to communicate well, the learner subgroups typically cannot solve the business problem.

Interventions in the learners' exposure to the problem situation occur at appropriate points in time to assist the learners in their development of the mindset required to be an effective general manager. The first intervention that is typically required occurs once a subgroup of learners has began working together toward solving the problem (e.g., sitting together, talking with each other, interacting, using a flip chart, etc.). The intervention involves asking each learner in the subgroup to take out a piece of paper and write down the problem that they are working together on solving. The learners are then asked to each read what problem it is that they are working together on trying to solve. Typically each learner will have described a different problem. The purpose of the intervention is to highlight two fundamental failures on behalf of everyone in the subgroup—failure to communicate and failure to clearly define what business problem, collectively, they are trying to solve.

The second intervention that is typically required occurs a short time after the learners in a subgroup have began applying the information processed from the first intervention and have began communicating. This intervention involves asking each learner in the subgroup to write down on a piece of paper what they believe is the objective of the business they are running. Each learner is then asked to read the objective they have written down. Typically there will be six different objectives given for the subgroup's business. The purpose of this intervention is to reinforce the importance of communication and to point out another common managerial failure—not identifying a clear goal, or priorities, for the business.

The third intervention that is commonly utilized occurs after the learners in a subgroup have began applying what they learned in the first two interventions. This intervention implements the same format from the prior interventions, however, the question asked of the learners is whether they feel the subgroup is working well together. Invariably, out of a subgroup of six learners, several will say that they do not believe the subgroup is working well together—yet they failed to speak up and mention to the other learners that they thought improvements could be made. The purpose of this intervention is emphasize that workers typically believe in popularity over performance and therefore, if something is going wrong they have a tendency not to speak up—they are more concerned about how the group thinks of them than they are concerned about the performance of the group.

The next commonly utilized intervention occurs when a subgroup of learners presents the results of their first business decision and in turn are given an overwhelming amount of data relevant to the next required decision (e.g., approximately thirty pages of information divided by functional areas). Predictably, one of the learners from the subgroup will ask that a copy be made of every piece of data for everybody in the subgroup. The intervention involves asking the learner why they want the copies. Typically the learner cannot come up with a need-based reason other than copies are traditionally provided. The purpose of the intervention is to emphasize the need for the learners to divide (and delegate) the work among the subgroup and to emphasize the utility in implementing procedures (and responsibility) for holding workers accountable for producing results in the work delegated to them.

The following intervention is typically required after the learners have been in the learning environment for some time (e.g., the subgroups have made multiple required business decisions) and a subgroup's business is not running the way it should-several significant mistakes have been made. The learners in the subgroup are asked who is accountable for the following decisions: sales price decisions, production decisions, finance decisions, and finally, who is accountable for deciding who is accountable. The learners' answers usually indicate individual accountability is unclear and that one learner is making the majority of the decisions. The purpose of this intervention is to illustrate the value of trust over control—i.e., the pitfalls of one person being accountable for all the activities and the decisions of the group. A second purpose of this intervention is to emphasize the utility in defining what each learner is responsible for producing and the outcomes they are accountable for achieving.

The remaining interventions that are predictably required involve functional specialty areas or involve a particular learner within a subgroup (although the entire subgroup is still intervened with) and therefore typically occur later in time during the simulation than the previously discussed interventions. One such intervention is employed when a subgroup is trying to debate the sales price issue. The learners in the subgroup are asked to write down all the facts that they understand about sales price, what variables they know affect sales price, and which of these variables can be manipulated (the simulation is designed to only allow manipulation of a few, but not all, of the variables known to affect sales price). Predictably, the subgroup has failed to properly identify the variables that can be manipulated. The purpose of the intervention is to highlight the fact that cause and effect relationships in a business setting are not necessarily approached the same way they would be in other settings (e.g., scientifically).

Another intervention—focused on an individual learner—occurs when adequate performance is not achieved by one of the learners in a subgroup. The subgroup is asked who is going to hold that learner accountable for the performance problem and what are they going to do about bad performance problems. A common answer is the subgroup does not have any plans to do anything about it. The purpose of the intervention is to illustrate how difficult it is to hold people accountable for necessary performance achievements and the negative impact not holding them accountable has on both individual performance as well as the performance of the overall group.

The last intervention frequently required occurs just prior to the closing of the simulation. The learners in a subgroup are each asked to write out the goals, objectives and strategic plan for their business. Each answer usually is something different, therefore indicating the subgroup has done no planning, no identification of goals and objectives for the purpose of their business. The purpose of the intervention is to emphasize the importance of strategic planning in determining the focus and the direction of the business and the value of not keeping that to one worker but rather sharing it with all workers with the requisite area of accountability.

It will be appreciated that the preceding discussion, designated “example,” is only an example and is not intended to further define or limit the scope of the present invention.

Those ordinarily skilled in the art will appreciate that in learning situations, such as in the illustrated development method 10, a learner's mind can become over loaded. The complexity of the situation encountered, can in some instances cause a learner to shut down, or withdraw, to the point that no learning takes place. The level of complexity that initiates withdrawal varies from learner to learner and within a learner from one point in time to another. Accordingly, in the preferred embodiment, step 14 further includes the step of recognizing when at least one of the learners withdraws from the learning environment 16, and the step of removing the withdrawn learner from the environment when the withdrawal is recognized. The step of removing the withdrawn learner necessarily follows the step of recognizing the withdrawal. The step of recognizing withdrawal preferably follows step 24 of assessing the existing mindset of the learners. The step of removing a withdrawn learner should only be implemented when a learner has truly withdrawn from the environment 16. That is, learners must process what they have learned and that processing requires some time. In this regard, the step of recognizing withdrawal should take into account this processing time. However, if a learner has truly withdrawn, the learner should be removed from the environment because there is a failure to learn, that while only temporary, is not reversible.

Given the temporary nature of a failure to learn, it is well within the ambit of the present invention to include steps directed at planning an alternative learning environment to place a withdrawn learner in once withdrawal is recognized. One such alternative embodiment is a career specific development method 100. Method 100 is similar to the previously described method 10 and like method 10 includes step 102 of identifying the mindset to be developed in a group of learners wherein the learners have a common career and the mindset is specific to the common career and step 104 of placing the learners in a learning environment to develop the mindset. Differing from method 10, however, the mindset is identified in step 102 not by interviewing workers or coworkers, but rather by retrieving the known set of knowledge, values and beliefs from a stored database. For example, the database could include the results of previous interviews of workers that have done effective work in the career common to the learners. Step 104 of method 100 is similar to the previously described step 14 of method 10, however, step 104 also includes the step of planning an alternative environment. The alternative environment will only be utilized if at least one of the learners withdraws from the original learning environment and in that event only the learner or learners that withdraws will be exposed to the alternative environment. In this regard, the alternative environment should be less complex than the original learning environment. The step of planning an alternative environment preferably precedes the step of exposing the learners to a problem situation. Similar to method 10, method 100 includes the step of recognizing when at least one of the learners withdraws from the learning environment. Unlike method 10, however, in method 100 the learner or learners that withdraws is not simply removed from the original learning environment. Method 100 further includes step 106 of placing the learner or learners that withdraws from the original learning environment into the planned alternative environment.

The embodiments of the career specific development method previously described are particularly designed for developing a mindset in a group of learners. However, as noted above, the principles of the present invention are equally applicable to developing a mindset in a single learner. One such alternative embodiment is a career specific development method 200. Method 200 includes step 202 of identifying the mindset to be developed in a learner wherein the mindset is specific to the learner's career and step 204 of placing the learner in a learning environment to develop the mindset. Steps 202 and 204 are similar to steps 12 and 14, respectively, of the previously described method 10. In step 202, however, the mindset is preferably determined by interviewing coworkers of the learner. In method 10, the step of assessing the learners' existing mindset was included in step 14. With a single learner, however, the learning environment can be specifically designed to maximize the development of that learner. In method 200, therefore, the step of assessing the learner's existing mindset is preferably included in both step 202 and step 204. In addition, in method 200 there is no need to remove the learner or place the learner in an alternative environment if the learner withdraws; the learning environment can simply be modified to accommodate the learner's ability to process what is learned.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any method not materially departing from but outside the literal scope of the invention as set forth in the following claims.

What is claimed is:

1. A method of developing a mindset in a group of learners, where the group shares a common career and the mindset is specific to the common career, said mindset development method comprising the steps of:
(a) identifying the mindset; and
(b) placing the learners in an environment to develop the mindset.

2. A mindset development method as claimed in claim 1,
step (b) being performed after step (a).

3. A mindset development method as claimed in claim 1,
step (b) including the steps of
(b₁) exposing the learners to a problem situation,
(b₂) intervening in the learners' exposure to the problem situation, and
(b₃) presenting mindset developing content to the learners.

4. A mindset development method as claimed in claim 3,
step (b₁) including the step of exposing the learners to an ambiguous decision so that the learners' exposure to the ambiguous decision creates a level of uncertainty in the learners sufficient to motivate the learners to learn the mindset to be developed.

5. A mindset development method as claimed in claim 4,
step (b₁) including the step of assessing each of the learners' existing mindset prior to exposing the learners to the ambiguous decision.

6. A mindset development method as claimed in claim 5,
if at least one of the learners' existing mindset is adequately advanced relative to the mindset to be developed so that exposure to the ambiguous decision does not create a motivational level of uncertainty,
then step (b₂) including the step of modifying the problem situation to create further uncertainty in said at least one of the learners until the motivational level is achieved.

7. A mindset development method as claimed in claim 5,
if at least one of the learners' existing mindset is inadequately advanced relative to the mindset to be developed so that exposure to the ambiguous decision creates an excessive level of uncertainty sufficient to hinder the motivation to learn the mindset to be developed,
then step (b₂) including the step of modifying the problem situation to reduce the uncertainty in said at least one of the learners until the motivational level is achieved.

8. A mindset development method as claimed in claim 4,
step (b₁) including the step of eliciting a response by at least one of the learners to the ambiguous decision.

9. A mindset development method as claimed in claim 8,
if the response is an action,
then step (b₃) including the steps of recognizing a level of risk associated with the action and presenting mindset developing content to motivate said at least one of the learners to modify future action in order to reduce the level of risk.

10. A mindset development method as claimed in claim 8,
if the response is inaction,
then step (b₃) including the steps of recognizing a level of risk associated with the inaction and presenting mindset developing content to motivate said at least one of the learners to take future action in order to reduce the level of risk.

11. A mindset development method as claimed in claim 3,
step (b₂) including the steps of assessing the environment, and modifying the environment to maximize the development of the mindset.

12. A mindset development method as claimed in claim 11,
step (b₂) including the steps of recognizing when at least one of the learners withdraws from the environment, and removing said at least one of the learners from the environment when said withdrawal is recognized.

13. A mindset development method as claimed in claim 11,
step (b₁) including the step of planning an alternative environment prior to exposing the learners to the problem situation,
step (b₂) including the steps of recognizing when at least one of the learners withdraws from the environment, and placing said at least one of the learners in the alternative environment when said withdrawal is recognized.

14. A mindset development method as claimed in claim 1,
step (a) including the step of determining the knowledge, values and beliefs specific to the learners' common career.

15. A mindset development method as claimed in claim 14,
step (a) including the step of interviewing people outside of the group of learners to determine said knowledge, values and beliefs.

16. A mindset development method as claimed in claim 15,
said people being coworkers of the group of learners.

17. A mindset development method as claimed in claim 16,
step (b) including the steps of determining a situation that simulates a problem that will develop said knowledge, values and beliefs, and exposing the group of learners to said situation.

18. A mindset development method as claimed in claim 15,
said people being workers that have done effective work in the learners' common career.

19. A mindset development method as claimed in claim 18,
step (a) including the steps of determining what the workers know about when doing the effective work, what the workers know how to do when doing the effective work, what the workers value when doing the effective work, and what the workers believe in when doing the effective work.

20. A mindset development method as claimed in claim 19,
step (b) including the steps of determining a situation that simulates a problem that will develop said what the workers know about when doing the effective work, what the workers know how to do when doing the effective work, what the workers value when doing the effective work, and what the workers believe in when doing the effective work, and exposing the group of learners to said situation.

21. A mindset development method as claimed in claim 1,
step (a) including the step of interviewing workers that have done effective work in the learners' common career to determine the knowledge, values and beliefs specific to the effective work,
step (b) including the steps of
exposing the learners to an ambiguous decision so that the learners' exposure to the ambiguous decision creates a level of uncertainty in the learners sufficient to motivate the learners to learn the knowledge, values and beliefs,
eliciting a response from at least one of the learners to the ambiguous decision,
recognizing a level of risk associated with the response, and
presenting content specific to the knowledge, values and beliefs to said at least one of the learners to modify future responses in order to reduce the level of risk.

22. A mindset development method as claimed in claim 1,
step (b) including the steps of determining learning levels of the individual learners, recognizing variances among the learning levels, and adjusting the environment to accommodate the variances.

23. A method of developing a mindset in a learner, where the mindset is specific to the learner's career, said mindset development method comprising the steps of:
(a) identifying the mindset; and
(b) placing the learner in an environment to develop the mindset.

24. A mindset development method as claimed in claim 23,
step (b) being performed after step (a).

25. A mindset development method as claimed in claim 23,
step (b) including the steps of
(b₂)exposing the learner to a problem situation,
(b₂) intervening in the learner's exposure to the problem situation, and
(b₃) presenting mindset developing content to the learner.

26. A mindset development method as claimed in claim 25,
step (b₁) including the step of exposing the learner to an ambiguous decision so that the learner's exposure to the ambiguous decision creates a level of uncertainty in the learner sufficient to motivate the learner to learn the mindset to be developed.

27. A mindset development method as claimed in claim 26,
step (b₁) including the step of assessing the learner's existing mindset prior to exposing the learner to the ambiguous decision.

28. A mindset development method as claimed in claim 27,
if the learner's existing mindset is adequately advanced relative to the mindset to be developed so that exposure to the ambiguous decision does not create a motivational level of uncertainty,
then step (b₂) including the step of modifying the problem situation to create further uncertainty in the learner until the motivational level is achieved.

29. A mindset development method as claimed in claim 27,
if the learner's existing mindset is inadequately advanced relative to the mindset to be developed so that exposure to the ambiguous decision creates an excessive level of uncertainty sufficient to hinder the motivation to learn the mindset to be developed,
then step (b₂) including the step of modifying the problem situation to reduce the uncertainty in the learner until the motivational level is achieved.

30. A mindset development method as claimed in claim 26, step (b₁) including the step of eliciting a response by the learner to the ambiguous decision.

31. A mindset development method as claimed in claim 30,
if the response is an action,
then step (b₃) including the steps of recognizing a level of risk associated with the action and presenting mindset developing content to motivate the learner to modify future action in order to reduce the level of risk.

32. A mindset development method as claimed in claim 30,
if the response is inaction,
then step (b₃) including the steps of recognizing a level of risk associated with the inaction and presenting mindset developing content to motivate the learner to take future action in order to reduce the level of risk.

33. A mindset development method as claimed in claim 25,
step (b₂) including the steps of assessing the environment, and modifying the environment to maximize the development of the mindset.

34. A mindset development method as claimed in claim 33,
step (b₂) including the steps of recognizing when the learner withdraws from the environment, and removing the learner from the environment when said withdrawal is recognized.

35. A mindset development method as claimed in claim 33,
step (b₁) including the step of planning an alternative environment prior to exposing the learner to the problem situation,
step (b₂) including the steps of recognizing when the learner withdraws from the environment, and placing the learner in the alternative environment when said withdrawal is recognized.

36. A mindset development method as claimed in claim 23,
step (a) including the step of determining the knowledge, values and beliefs specific to the learner's career.

37. A mindset development method as claimed in claim 36,
step (a) including the step of interviewing people to determine said knowledge, values and beliefs.

38. A mindset development method as claimed in claim 37,
said people being coworkers of the learner.

39. A mindset development method as claimed in claim 38,
step (b) including the steps of determining a situation that simulates a problem that will develop said knowledge, values and beliefs, and exposing the learner to said situation.

40. A mindset development method as claimed in claim 37,
said people being workers that have done effective work in the learner's career.

41. A mindset development method as claimed in claim 40,
step (a) including the steps of determining what the workers know about when doing the effective work, what the workers know how to do when doing the effective work, what the workers value when doing the effective work, and what the workers believe in when doing the effective work.

42. A mindset development method as claimed in claim 41,
step (b) including the steps of determining a situation that simulates a problem that will develop said what the workers know about when doing the effective work, what the workers know how to do when doing the effective work, what the workers value when doing the effective work, and what the workers believe in when doing the effective work, and exposing the learner to said situation.

43. A mindset development method as claimed in claim 23,
step (a) including the step of interviewing workers that have done effective work in the learner's career to determine the knowledge, values and beliefs specific to the effective work,
step (b) including the steps of
exposing the learner to an ambiguous decision so that the learner's exposure to the ambiguous decision creates a level of uncertainty in the learner sufficient to motivate the learner to learn the knowledge, values and beliefs,
eliciting a response from the learner to the ambiguous decision,
recognizing a level of risk associated with the response, and
presenting content specific to the knowledge, values and beliefs to the learner to modify future responses in order to reduce the level of risk.
